(19) United States
(12) Patent Application Publication
(10) Pub. No.: US 2025/0251868 A1
(43) Pub. Date: Aug. 7, 2025

(54) MEMORY CONTROLLER, STORAGE DEVICE INCLUDING MEMORY CONTROLLER, AND METHOD OF OPERATING THE SAME

(71) Applicant: SAMSUNG ELECTRONICS CO., LTD., Suwon-si (KR)

(72) Inventors: Hyejin JANG, Suwon-si (KR); Jingeun PARK, Suwon-si (KR); Heongwon LEE, Suwon-si (KR); Joonyong JEONG, Suwon-si (KR)

(73) Assignee: SAMSUNG ELECTRONICS CO., LTD., Suwon-si (KR)

(21) Appl. No.: 19/020,704

(22) Filed: Jan. 14, 2025

(30) Foreign Application Priority Data
Feb. 7, 2024 (KR) 10-2024-0019173

(51) Int. Cl. G06F 3/06

(52) U.S. Cl. CPC G06F 3/0619; G06F 3/0631; G06F 3/0659; G06F 3/0679

(57) ABSTRACT

A memory controller replaces a bad block of a given super block with a reserved block, and updates a bad block bitmap. The memory controller includes a super block classifier configured to determine the given super block as a free block or a reserved block according to a number of bad blocks of the given super block. When the given super block is determined as the free block, memory controller inserts an identifier of the given super block into a free block list.

### CROSS-REFERENCE TO RELATED APPLICATION

This application is based on and claims priority under 35 U.S.C. § 119 to Japanese Patent Application No. 10-2024-0019173, filed on Feb. 7, 2024, in the Korean Intellectual Property Office, the disclosure of which is incorporated by reference herein in its entirety.

### BACKGROUND

Embodiments relate to a storage device and a method of operating the same.

As a non-volatile memory, a flash memory may retain stored data even when power is interrupted. A storage device including a flash memory such as a solid state drive (SSD) and a memory card is being widely used. Also, due to the recent rapid technological developments, the amount of data to be processed is increasing. Therefore, demand for high-performance/high-reliability storage devices is increasing.

In a storage device, a reserved region refers to a region allocated for replacement of a bad block. To improve the performance of a storage device, a technique for efficiently managing a reserved region is demanded.

### SUMMARY

Embodiments provide efficient management of a reserved region of a storage device.

Provided herein is a storage device including: a non-volatile memory including a first plurality of super blocks each including a plurality of memory blocks; and a memory controller configured to determine that a first super block, which is one of the first plurality of super blocks, includes at least one initial bad block, replace the at least one initial bad block with at least one reserved block, and update a bad block bitmap based on the at least one initial bad block, wherein the memory controller includes a super block classifier configured to determine the first super block as a free block or a reserved block according to a number of the at least one initial bad block of the first super block based on the bad block bitmap and, based on the first super block being determined as the free block, insert the first super block into a free block list, wherein the free block list identifies a second plurality of super blocks, and the first plurality of super blocks includes the second plurality of super blocks.

Also provided herein is a method of operating a memory controller, the method including: determining that a first super block includes at least one initial bad block, the first super block being one of a first plurality of super blocks each including a plurality of memory blocks; replacing the at least one initial bad block with at least one reserved block; updating a bad block bitmap based on the at least one initial bad block; determining the first super block as a free block or a reserved block according to a number of the at least one initial bad block of the first super block based on the bad block bitmap; and inserting an identifier of the first super block into a free block list based on the first super block being determined as the free block, wherein the free block list identifies a second plurality of super blocks, and the first plurality of super blocks includes the second plurality of super blocks.

Also provided herein is a storage device including: a non-volatile memory including a first plurality of super blocks each including a plurality of memory blocks; and a memory controller configured to determine whether a first super block, which is one of the first plurality of super blocks, includes at least one initial bad block, and replace the at least one initial bad block with at least one reserved block, wherein the memory controller includes: a super block classifier configured to determine the first super block as a free block and insert the first super block into a free block list based on a number of the at least one initial bad block of the first super block being less than or equal to pre-set K that is an integer greater than or equal to 1, wherein the free block list identifies a second plurality of super blocks, and the first plurality of super blocks includes the second plurality of super blocks, and a super block allocator configured to allocate the first super block for writing in response to a write command.

### BRIEF DESCRIPTION OF DRAWINGS

Embodiments will be more clearly understood from the following detailed description taken in conjunction with the accompanying drawings in which:

FIG. 1 is a block diagram showing a storage system according to an embodiment;

FIG. 2 is a block diagram showing a memory controller according to an embodiment;

FIG. 3 is a block diagram showing a memory controller according to an embodiment;

FIG. 4 is a diagram showing that a memory controller according to an embodiment increases an over-provisioning (OP) region by utilizing a reserved region;

FIGS. 5A to 5C are diagrams illustrating an operation of a memory controller for classifying super blocks;

FIG. 5D is a diagram showing a BBB for the super blocks of FIGS. 5B and 5C;

FIG. 6 is a diagram illustrating the structure of a NVM according to an embodiment;

FIG. 7 is a diagram illustrating a free block list used by a memory controller, according to an embodiment;

FIG. 8 is a diagram showing a method of operating a storage device, according to an embodiment;

FIG. 9 is a diagram showing a method of operating a storage device, according to an embodiment;

FIG. 10 is a diagram showing a method of operating a storage device, according to an embodiment;

FIGS. 11A and 11B are diagrams showing a method of operating a storage device, according to an embodiment;

FIG. 12 is a diagram showing a method of operating a memory controller according to an embodiment;

FIG. 13 is a block diagram showing an example in which a storage device according to embodiments is applied to an SSD system; and

FIG. 14 is a diagram showing a computing system according to an embodiment.

### DETAILED DESCRIPTION OF EXAMPLE EMBODIMENTS

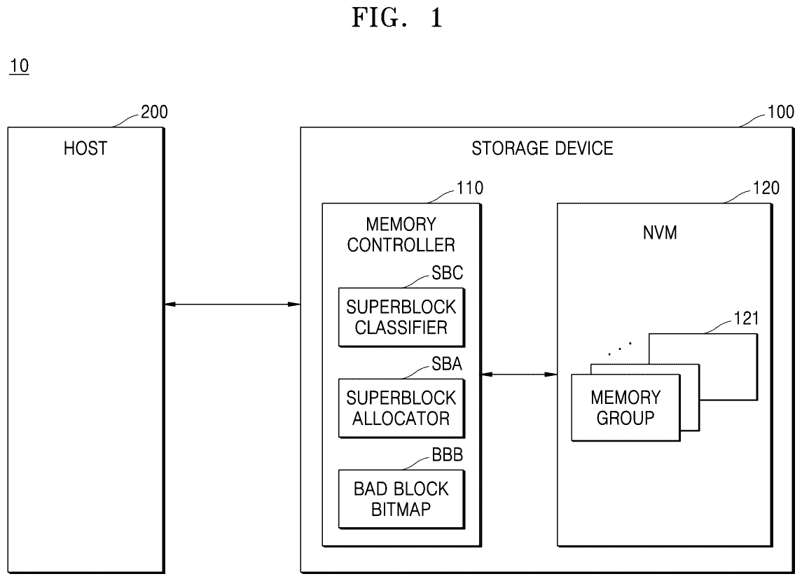

FIG. 1 is a block diagram showing a storage system 10 according to an embodiment.

Referring to FIG. 1, the storage system 10 may include a storage device 100 and a host 200, and the storage device 100 may include a controller 110 and a non-volatile memory (NVM) 120. The memory controller 110 may include a super block classifier (SBC) and a super block allocator (SBA). Hereinafter, for convenience, the memory controller 110 may also be referred to as a “controller”. Each of the SBC and SBA may be implemented by custom hardware, a processor executing instructions from a memory or a combination of hardware and software.

The host 200 may communicate with the storage device 100 through various interfaces. For example, the host 200 may be implemented as an application processor (AP) or a system-on-a-chip (SoC). Furthermore, for example, the host 200 may be implemented as an integrated circuit, a motherboard, or a database server, but is not limited thereto. The host 200 may transmit a write request or a read request to the storage device 100, and the storage device 100 may write data to the NVM 120 or read data from the NVM 120 in response to the write request or the read request.

The NVM 120 may include a plurality of memory groups 121. The plurality of memory groups 121 may each include a plurality of super memory blocks (hereinafter referred to as “super blocks”). The plurality of super blocks may each include a plurality of memory blocks (hereinafter referred to as “blocks”), the plurality of blocks may each include a plurality of pages, and the plurality of pages may each include a plurality of memory cells. For example, a super block and/or a block may be an erase unit, and a page may be a write/read unit. According to some embodiments, the plurality of memory groups 121 may include a plurality of memory chips, a plurality of dies, or a plurality of planes. According to an embodiment, the NVM 120 may include a flash memory device, e.g., a NAND flash memory device. However, embodiments are not limited thereto, and the NVM 120 may include a resistive memory device such as a resistive RAM (ReRAM), a phase change RAM (PRAM), and a magnetic RAM (MRAM).

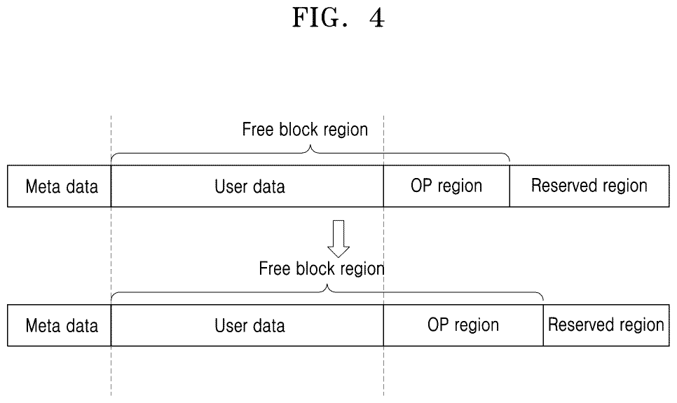

Although FIG. 1 shows that a bad block bitmap (BBB) is included in the controller 110, embodiments are not limited thereto, and, according to some embodiments, a BBB may be loaded into a memory chip outside a controller chip on which the controller 110 is implemented, e.g., a dynamic random access memory (DRAM) chip (e.g., 130 of FIG. 4).

The storage system 10 may be implemented as, for example, a personal computer (PC), a data server, a network-attached storage, an Internet of Things (IoT) device, or a portable electronic device. The portable electronic device may be a laptop computer, a mobile phone, a smart phone, a tablet PC, a personal digital assistant (PDA), an enterprise digital assistant (EDA), a digital still camera, a digital video camera, an audio device, a portable multimedia player (PMP), a personal navigation device (PND), an MP3 player, a handheld game console, an e-book device, a wearable device, etc.

According to some embodiments, the storage device 100 may be an internal memory embedded in an electronic device. For example, the storage device 100 may be a solid state drive (SSD), an embedded universal flash storage (UFS) memory device, or an embedded multi-media card (eMMC). According to some embodiments, the storage device 100 may be an external memory that may be attached to and detached from an electronic device. For example, the storage device 100 may be a UFS memory card, a compact flash (CF) card, a secure digital (SD) card, a micro SD card, a mini SD card, an extreme digital (xD) card, or a memory stick.

The storage device 100 according to an embodiment includes the NVM 120, which includes a plurality of super blocks (also referred to as a first plurality of super blocks) including a plurality of memory blocks, and the memory controller 110 configured to determine whether a first super block, which is one of the plurality of super blocks, includes at least one initial bad block, replace the at least one initial bad block with at least one reserved block, and update a BBB based on the at least one initial bad block. The memory controller 110 may include a SBC configured to determine the first super block as a free block or a reserved block according to the number of the at least one initial bad block of the first super block based on the BBB and, when the first super block is determined as the free block, insert the first super block into a free block list. For example, inserting the first super block may refer to inserting an identifier of the first super block into the free block list, and the free block list holds identifiers of a second plurality of super blocks. In an example, the second plurality of super blocks are a subset of the first plurality of super blocks (the first plurality of super blocks being all the super blocks of the NVM 120). The SBC may determine the first super block as the reserved block when the number of initial bad blocks of the first super block is greater than N (N is an integer greater than or equal to 0). The SBC may determine the first super block as the free block when the number of initial bad blocks of the first super block is equal to or less than a pre-set N (N is an integer greater than or equal to 0). The memory controller 110 may further include a SBA configured to allocate a super block for writing in response to a write command. The SBA may be configured to select the first super block from among super blocks included in the free block list, determine whether the selected first super block is a normal super block based on the BBB, and, when the first super block is a normal super block, allocate the first super block for writing. The SBA may select the first super block, which is a partial super block, from among super blocks included in the free block list. The SBA may be configured to allocate the selected first super block for writing when a write command is of a second type from between a first type and a second type. The first type may correspond to a host command received from a host, and the second type may correspond to an internal command based on the internal operation of the memory controller. The internal operation may include garbage collection. When writing, the memory controller 110 may exclude at least one initial bad block of the allocated first super block (partial super block) from data striping. The SBA may be configured to allocate the first super block for writing when a write command is of the first type from between the first type and the second type and the number of free blocks included in a free block list is equal to or less than M (M is a positive integer). When a write command is of the first type and the number of free blocks included in the free block list is greater than M, the SBA may re-select one from among the super blocks included in the free block list for the writing. For example, the number M of free blocks in the free block list for allocation may be the sum of the critical number of free blocks for garbage collection triggering and the number of partial super blocks included in the free block list.

The storage device 100 according to an embodiment includes the NVM 120, which includes a plurality of super blocks including a plurality of memory blocks, and the memory controller 110 configured to check the initial bad block of a first super block, which is one of the plurality of super blocks and replace the at least one initial bad block with at least one reserved block. The memory controller 110 may include the SBC configured to, when the number of the at least one initial bad block of the first super block is equal to or less than pre-set K (K is an integer greater than or equal to 1), determine the first super block as a free block and insert the first super block into a free block list and the SBA configured to allocate the first super block for writing in response to a write command. The SBA may be configured to select a second super block, which is any one from among super blocks in the free block list, in response to a write command, determine whether at least one condition from among conditions for allocating the second super block is satisfied, and, when the at least one condition is satisfied, allocate the second super block for the writing. The conditions may include a first condition that the second super block is a normal super block, a second condition that the write command is of the second type from between the first type and the second type, and a third condition that the number of super blocks included in the free block list is less than M. When none of the above-stated conditions is satisfied, the SBA may select a third super block, which is any one of the super blocks in the free block list, in response to a write command. The third super block may be different from the second super block.

The storage device 100 according to an embodiment may utilize a reserved region for a storage space.

The storage device 100 according to an embodiment may utilize a part of the reserved region as an over-provisioning (OP) region.

The storage device 100 according to an embodiment may improve random write performance by utilizing a reserved region.

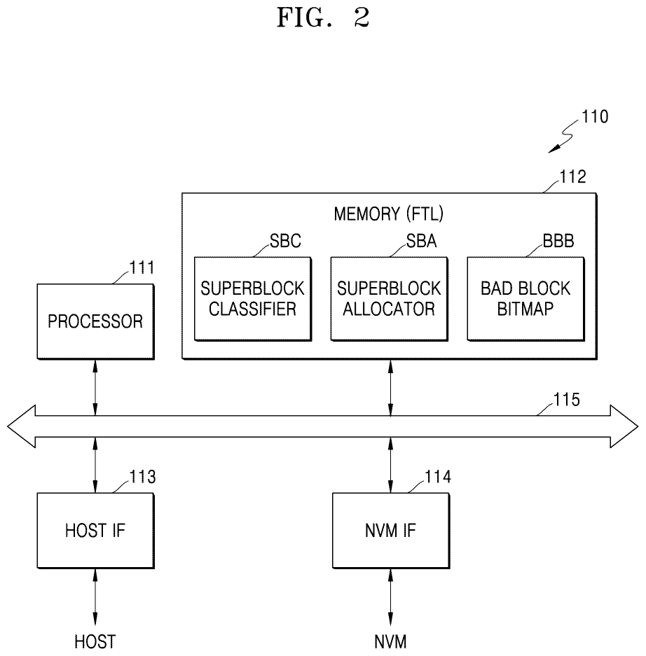

FIG. 2 is a block diagram showing a memory controller according to an embodiment. FIG. 2 may be described with reference to FIG. 1, and descriptions identical to those given above may be omitted.

Referring to FIGS. 1 and 2 together, the memory controller 110 may include a processor 111, a memory 112, a host interface 113, and a NVM interface 114, which may be communicate with one another through a bus 115. The processor 111 may include a central processing unit or a microprocessor and may control the overall operation of the memory controller 110. According to an embodiment, the processor 111 may be implemented as a multi-core processor, e.g., a dual-core processor or a quad-core processor.

The memory 112 operates under the control of the processor 111 and may be used as an operation memory, a buffer memory, a cache memory, etc. For example, the memory 112 may be implemented with a volatile memory such as a DRAM and an SRAM or a non-volatile memory such as a PRAM and a flash memory. For example, the memory 112 may store a flash translation layer (FTL) code that may be executed by the processor 111. For example, when the storage device 100 is booted, the FTL code may be loaded from the NVM 120 to the memory 112.

The SBC, the SBA, and the BBB may be loaded into the memory 112. The SBC and the SBA may be implemented in firmware or software and may be loaded into the memory 112. However, embodiments are not limited thereto, and, according to some embodiments, the SBC and the SBA may be implemented in hardware and may be arranged outside the memory 112.

The host interface 113 may provide an interface between a host HT and the memory controller 110. For example, the host interface 113 may provide an interface based on an universal serial bus (USB), an MMC, a PCIExpress (PCI-E), an AT attachment (ATA), a serial AT attachment (SATA), a parallel AT attachment (PATA), a small computer system interface (SCSI), a serial attached SCSI (SAS), an enhanced small disk interface (ESDI), and an integrated drive electronics (IDE).

The NVM interface 114 may provide an interface between the memory controller 110 and the NVM 120. For example, meta data such as a BBB and a mapping table, write data, and read data may be transmitted and received between the memory controller 110 and the NVM 120 through the NVM interface 114. In an embodiment, the number of NVM interfaces 114 may correspond to the number of NVM chips included in the storage device 100 or the number of channels between the memory controller 110 and the NVM 120.

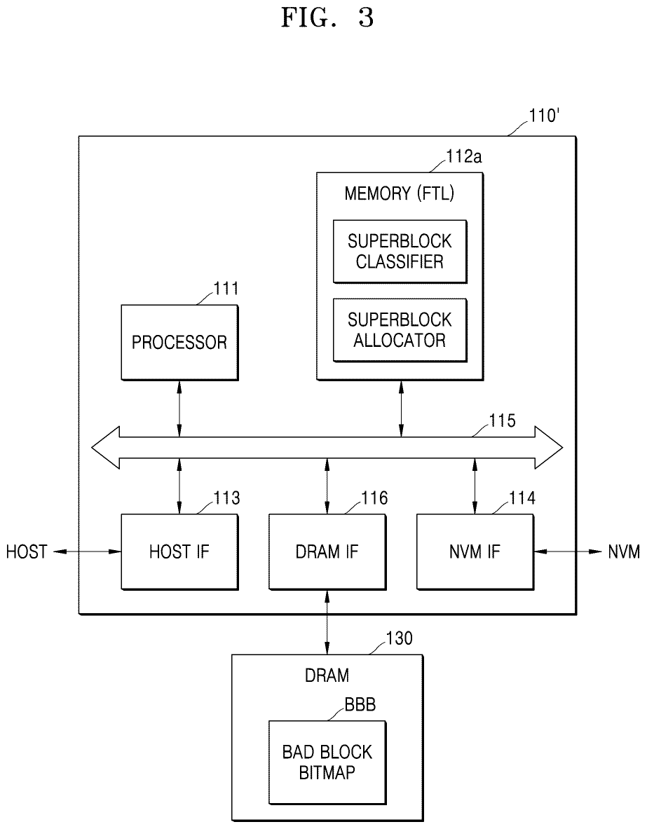

FIG. 3 is a block diagram showing a memory controller 110′ according to an embodiment.

Referring to FIG. 3, the memory controller 110′ may include the processor 111, a memory 112a, the host interface 113, the NVM interface 114, and a DRAM interface 116, which may communicate with one another through the bus 115. Since the memory controller 110′ according to the present embodiment may correspond to a modified example of the memory controller 110 of FIG. 2, descriptions identical to those already given above will be omitted. According to the present embodiment, a BBB may be loaded into a DRAM 130. The DRAM interface 116 may provide an interface between the memory controller 110′ and the DRAM 130. For example, some data included in the BBB may be transmitted and received between the memory controller 110′ and the DRAM 130 through the DRAM interface 116.

FIG. 4 is a diagram showing that a memory controller according to an embodiment increases an OP region by utilizing a reserved region.

FIG. 4 may be described with reference to FIG. 1. Referring to FIG. 4, meta data is data generated by the storage system 10 to manage user data or the NVM 120. Meta data may include mapping information for transforming a logical address into a physical address to access data stored in the NVM 120.

A free block region may refer to a region including free blocks. Free blocks may be included in a free block list and may refer to blocks that do not store valid user data. For example, free blocks may be blocks on which an erase operation has been completed and blocks available for a program operation again. Valid user data may be stored in free blocks. Also, free blocks may be used to perform garbage collection to store valid user data. A user space may refer to a region of free blocks in which valid user data is stored. An OP region may refer to a temporary work space of the memory controller 110 for writing valid data. For example, an OP region may include free blocks for performing garbage collection. In other words, when free blocks are used for garbage collection, the corresponding free blocks may be classified as free blocks of an OP region. In another example, when free blocks temporarily store data to be written to a DRAM, the corresponding free blocks may be classified as free blocks of an OP region.

A reserved region may refer to a region for block replacement for a bad block. Reserved blocks are blocks of a reserved region and may refer to blocks pre-defined for block replacement for bad blocks.

The memory controller 110 according to an embodiment may use blocks that satisfy a particular condition from among blocks in a reserved region for garbage collection. Therefore, the reserved region may decrease and the OP region may increase.

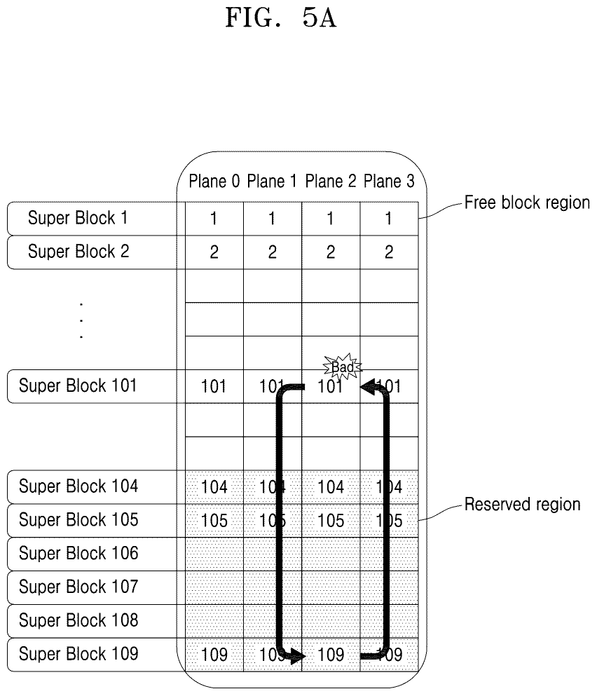

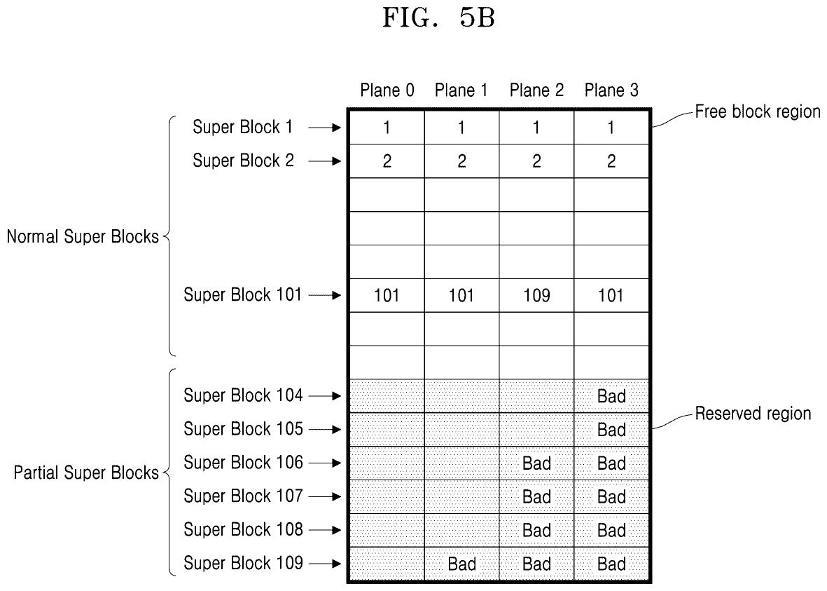

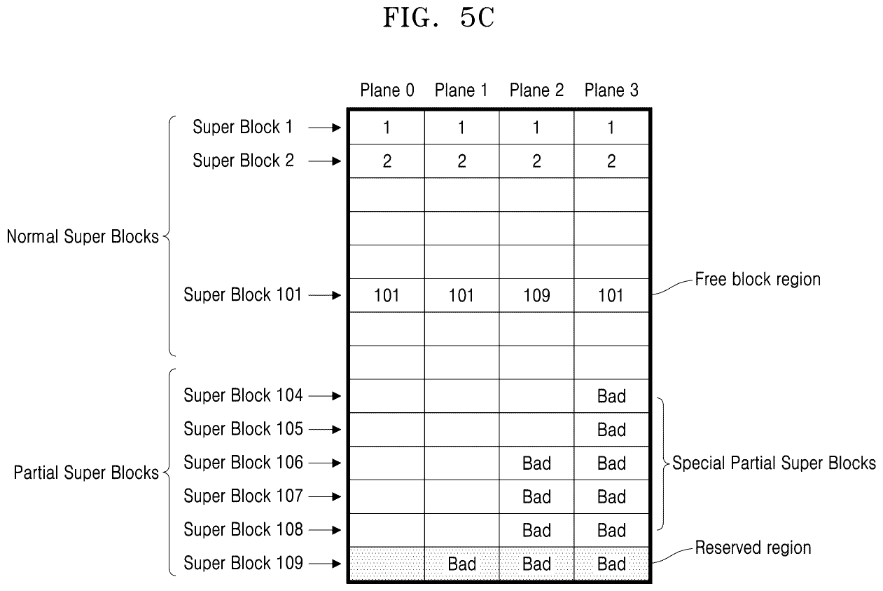

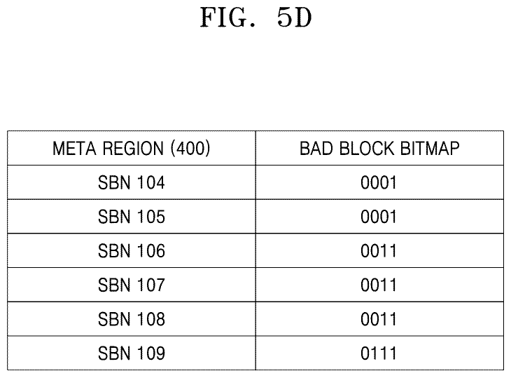

FIGS. 5A to 5C are diagrams illustrating an operation of a memory controller for classifying super blocks. FIG. 5D is a diagram showing a BBB for the super blocks of FIGS. 5B and 5C.

FIGS. 5A to 5D may be described with reference to FIG. 1. Although FIGS. 5A to 5C illustrate super blocks for four planes for convenience of explanation, embodiments are not limited thereto, and super blocks may include blocks of various numbers of planes, dies, and chips. Although a meta data region is omitted in FIGS. 5A to 5D for convenience of explanation, super blocks may be included in a meta data region.

Referring to FIG. 5A, Super Blocks 1 to 109 each include blocks included in four planes, that is, Planes 0 to 3. In detail, Super Block 1 is a set of blocks in a first line from among blocks included in Planes 0 to 3, and Super Block 109 is a set of blocks in a 109-th line from among blocks included in Planes 0 to 3. Super Blocks 104 to 109 are super blocks defined as blocks in a reserved region.

FIG. 5a shows a case where a block of Plane 2 from among blocks of Super Block 101 is a bad block. For example, from among the blocks of Super Block 101, the block of Plane 2 may be an initial bad block. The initial bad block may refer to a bad block formed during the manufacturing process of the NVM 120. The memory controller 110 may detect initial bad blocks during a format process. The memory controller 110 may replace an initial bad block with a block in a reserved region. For example, the memory controller 110 may modify the mapping relationship between a logical page number (LPN) and a physical page number (PPN). The memory controller 110 may replace the initial bad block with a block of Plane 2 from among blocks of Super Block 109.

The memory controller 110 may replace initial bad blocks with blocks in a reserved region. FIG. 5B is a diagram showing that initial bad blocks are replaced with blocks in a reserved region. Bad blocks in a free block region are replaced with some blocks of Super Blocks 104 to 109. Referring to FIG. 5B, replaced blocks are marked as Bad. Super blocks including bad blocks like Super Blocks 104 to 109 may be referred to as partial super blocks. A super block that does not include a bad block like Super Block 1 may be referred to as a normal super block.

Referring to FIG. 5C, the memory controller 110 may use partial super blocks in a reserved region as free blocks for writing valid user data when a particular condition is satisfied. In other words, the memory controller 110 may insert partial super blocks that satisfy a particular condition from among the partial super blocks in the reserved region, into a free block list. Partial super blocks inserted into the free block list may be referred to as special partial super blocks.

For example, the memory controller 110 may use super blocks (Super Blocks 104 to 108) having two or less bad blocks as free blocks for writing valid user data. The memory controller 110 may use the super blocks (Super Blocks 104 to 108) for garbage collection for writing valid user data. For convenience of explanation, an example of using super blocks (Super Blocks 104 to 108) having two or less bad blocks as free blocks has been described. However, embodiments are not limited thereto, and the number of bad blocks for switching partial super blocks of a reserved region to free blocks may vary.

FIG. 5D is a diagram showing a BBB for the super blocks of FIGS. 5B and 5C. The BBB may have a meta structure in the unit of super blocks. A meta region 400 may include super block numbers (SBNs). The SBN of super block 104 is 104, and SBNs of super blocks 105 to 109 may also be determined in this regard. FIG. 5D shows a BBB of the Super Blocks 104 to 109 of FIGS. 5B and 5C. The memory controller 110 may use the BBB to determine whether a particular super block is a normal super block or a partial super block. For example, the memory controller 110 may determine that the BBB for Super Block 104 is not 0 and determine that Super Block 104 is a partial super block.

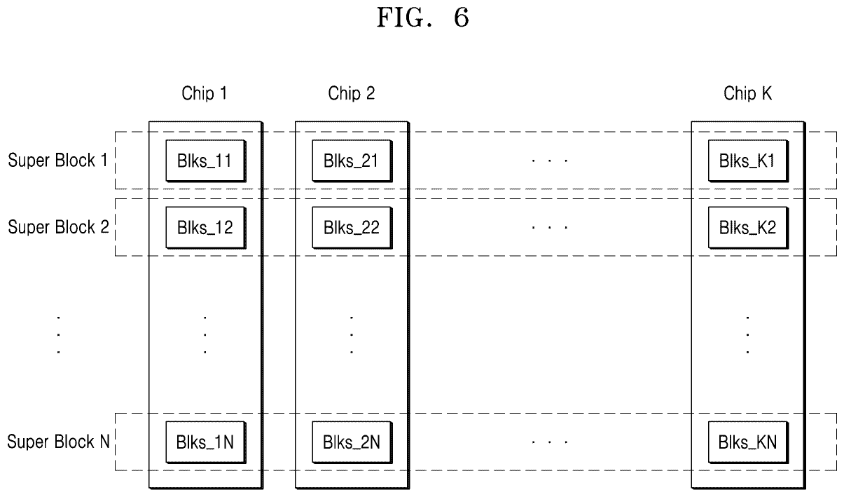

FIG. 6 is a diagram illustrating the structure of a NVM according to an embodiment.

FIG. 6 may be described with reference to FIG. 1. Referring to FIG. 6, the NVM 120 may include a plurality of chips Chip 1 to Chip k. k is a positive integer. The plurality of chips Chip 1 to Chip k may each include a plurality of blocks. A chip Chip 1 may include blocks Blk_11 to Blk_1N, a chip Chip 2 may include blocks Blk_21 to Blk_2N, and a chip Chip k may include blocks Blk_K1 to Blk_KN. N is a positive integer.

Super block 1 is a set of blocks Blk_11 to Blk_K1 of the plurality of chips Chip 1 to Chip k. Super Block 2 is a set of blocks Blk_12 to Blk_K2 of the plurality of chips Chip 1 to Chip k. Super Block N is a set of blocks Blk_1N to Blk_KN of a plurality of chips Chip 1 to Chip k. A flash translate layer (FTL) of the memory controller 110 may perform parallel processing (interleaving) for simultaneously writing data to the plurality of chips Chip 1 to Chip k based on super blocks, that is, Super Blocks 1 to N. Blocks with the same plane offset classified for each channel and each bank may become one super block. When a data write request is received, the FTL may request data write to all chips simultaneously in the unit of super blocks.

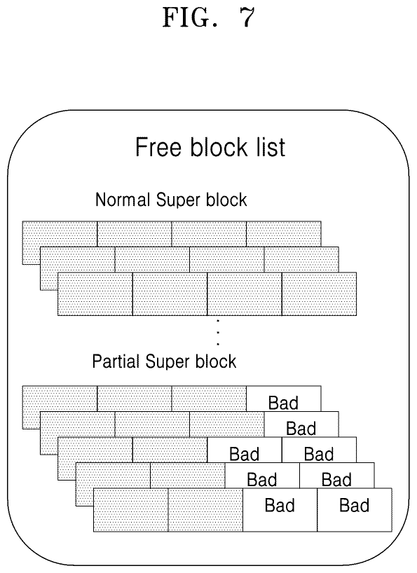

FIG. 7 is a diagram illustrating a free block list used by a memory controller, according to an embodiment.

FIG. 7 may be described with reference to FIG. 1. Free blocks may be included in a free block list and may refer to blocks that do not store valid user data. The free block list may include normal super blocks without a bad block and may include partial super blocks each including at least one bad block. Partial super blocks included in the free block list may be referred to as special partial super blocks.

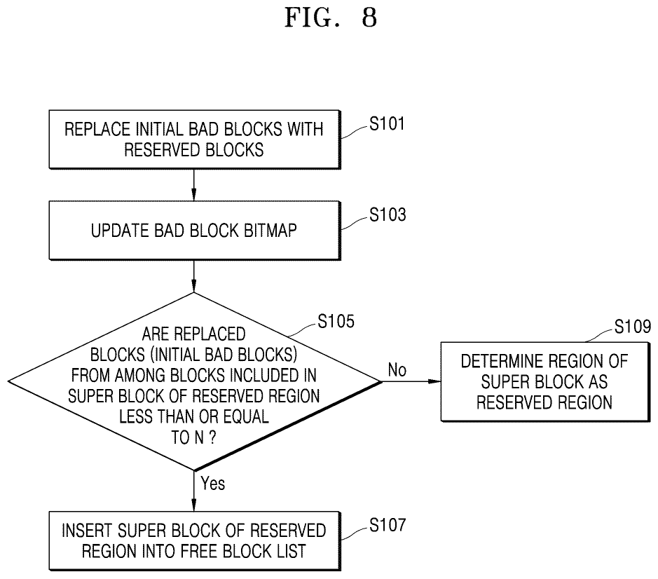

FIG. 8 is a diagram showing a method of operating a storage device, according to an embodiment.

FIG. 8 may be described with reference to FIG. 1. Referring to FIG. 8, in operation S101, the memory controller 110 may replace initial bad blocks with reserved blocks. For example, after performing FTL format, the memory controller 110 may determine initial bad blocks and replace the initial bad blocks with reserved blocks.

In operation S103, the memory controller 110 may update a BBB. The memory controller 110 may mark reserved blocks that replaced the initial bad blocks as bad in the BBB for super blocks of a reserved region.

In operation S105, the memory controller 110 may determine the number of replaced blocks (initial bad blocks) from among blocks included in the super blocks of the reserved region. The memory controller 110 may determine whether the number of replaced blocks from among the blocks included in the super blocks is equal to or less than N. N is a positive integer. For example, the memory controller 110 may determine whether the number of replaced blocks from among blocks included in the super blocks is equal to or less than N based on the BBB.

In operation S107, when the number of replaced blocks is equal to or less than N, the memory controller 110 may insert super blocks of the reserved region into a free block list.

In operation S109, when the number of replaced blocks is greater than N, the memory controller 110 may maintain the super blocks as reserved region. The number N of bad blocks included in super blocks, which serves as a criterion for inserting super blocks of a reserved region into a free block list, may be determined in advance. For example, the value of N may be determined based on the addressing overhead of reading a replacement block of a given plane from a reserved region to replace a bad block in the given plane in the free region.

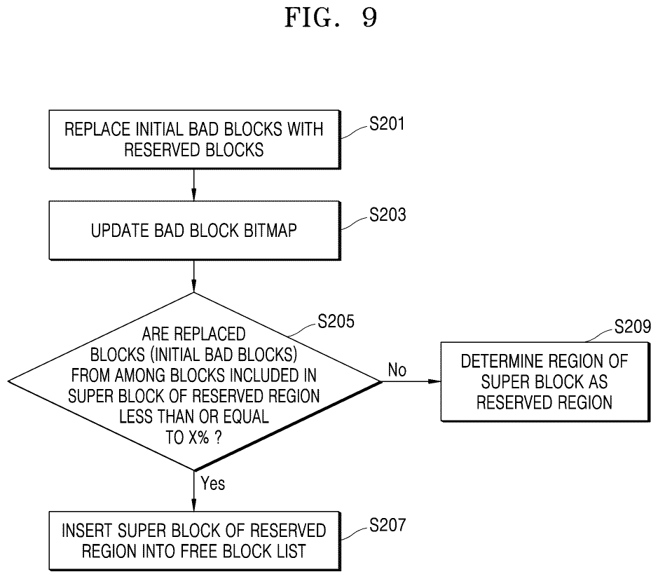

FIG. 9 is a diagram showing a method of operating a storage device, according to an embodiment.

FIG. 9 may be described with reference to FIGS. 1 and 8. Descriptions identical to those already given above with reference to FIG. 8 may be omitted. Referring to FIG. 9, in operation S201, the memory controller 110 may replace initial bad blocks with reserved blocks. In operation S203, the memory controller 110 may update a BBB. In operation S205, the memory controller 110 may determine the number of replaced blocks (initial bad blocks) from among blocks included in the super blocks of the reserved region. In operation S207, when the number of replaced blocks is equal to or less than N, the memory controller 110 may insert super blocks of the reserved region into a free block list. In operation S209, when the number of replaced blocks is greater than N, the memory controller 110 may determine a corresponding region of super blocks as a reserved region. The proportion X % of bad blocks included in super blocks, which serves as a criterion for inserting super blocks of a reserved region into a free block list, may be determined in advance. For example, X % may be determined in advance to be within the range from 12.5% to 15%.

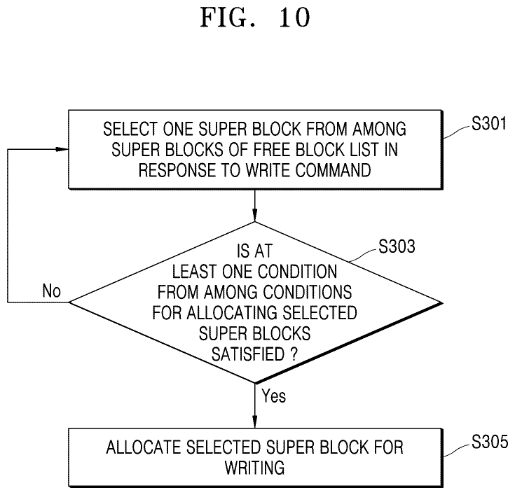

FIG. 10 is a diagram showing a method of operating a storage device, according to an embodiment.

FIG. 10 may be described with reference to FIG. 1. Referring to FIG. 10, in operation S301, the memory controller 110 may select one super block from among super blocks in a free block list in response to a write command.

In operation S303, the memory controller 110 may determine whether at least one condition from among conditions for allocating a selected super block for writing is satisfied. The conditions for allocating a selected super block for writing may include when the selected super block is a normal super block, when the type of a write command is a second type, and when the number of free blocks included in the free block list is less than M.

In operation S305, the memory controller 110 may allocate the selected super block for writing if at least one of the conditions for allocating the selected super block is satisfied. When none of the conditions for allocating the selected super block is satisfied, the memory controller 110 may re-select one super block from among the super blocks in the free block list in response to the write command. Then, the memory controller 110 may repeat the above-stated procedures to allocate a super block for writing.

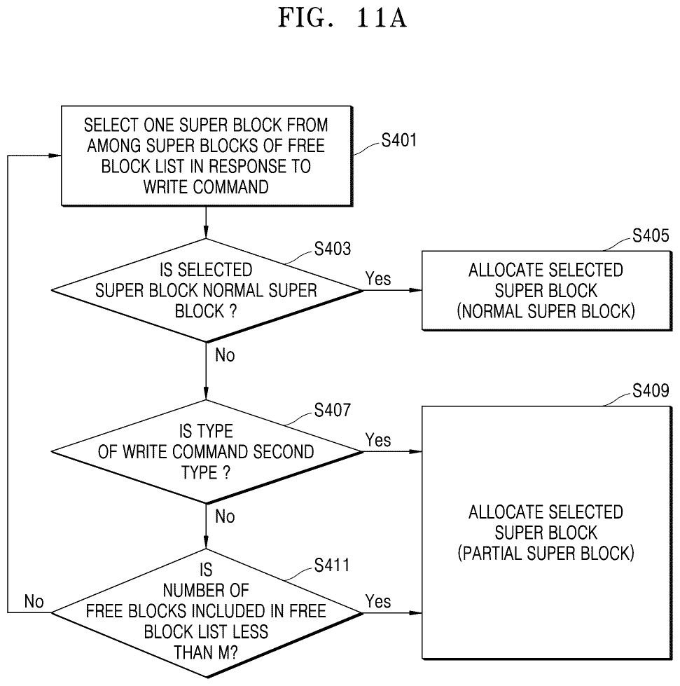

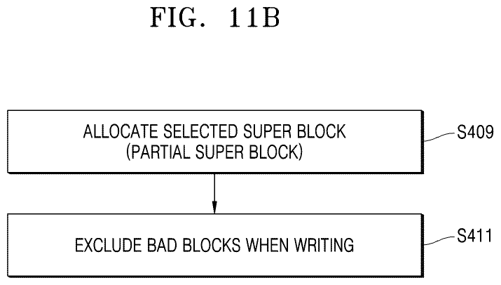

FIGS. 11A and 11B are diagrams showing a method of operating a storage device, according to an embodiment.

FIGS. 11A and 11B may be described with reference to FIG. 1. Referring to FIG. 11A, in operation S401, the memory controller 110 may select one super block from among super blocks in a free block list in response to a write command.

In operation S403, the memory controller 110 may determine whether the selected super block is a normal super block. For example, the memory controller 110 may determine whether the selected super block is a normal super block based on a BBB for the selected super block. In other words, when the value of the BBB for the selected super block is 0, the memory controller 110 may determine that the selected super block is a normal super block. When the value of the BBB for the selected super block is not 0, the memory controller 110 may determine that the selected super block is a partial super block. In operation S405, when the selected super block is a normal super block, the memory controller 110 may allocate the selected super block (normal super block) for writing.

In operation S407, when the selected super block is not a normal block (i.e., a partial super block), the memory controller 110 may determine the type of the write command. The memory controller 110 may determine whether the write command is of a first type or a second type. The first type may correspond to a host command received from a host. The second type may correspond to an internal command based on an internal operation of the memory controller. In operation S409, when the write command is of the second type, the memory controller 110 may allocate the selected super block (partial super block) for writing.

In operation S411, when the write command is of the first type, the memory controller 110 may determine whether the number of free blocks included in the free block list is less than M. M is a positive integer. When the number of free blocks included in the free block list is greater than M, the memory controller 110 may re-select one of super blocks included in the free block list for writing. In other words, the memory controller 110 may re-start operations from operation S401. When the number of free blocks included in the free block list is less than M (M is a positive integer), in operation S409, the memory controller 110 may allocate the selected super block (partial super block) for writing. According to an embodiment, the number M of free blocks in the free block list, which is the criterion for allocating a selected super block for writing, may be the sum of ‘the critical number of free blocks for garbage collection triggering’ and ‘the number of partial super blocks included in the free block list’.

Referring to FIG. 11B, in operation S409, the memory controller 110 may allocate the selected super block (partial super block) for writing. In operation S411, the memory controller 110 may exclude bad blocks when writing. In detail, the memory controller 110 may exclude at least one initial bad block of the allocated partial super block from data striping and perform writing in response to the write command.

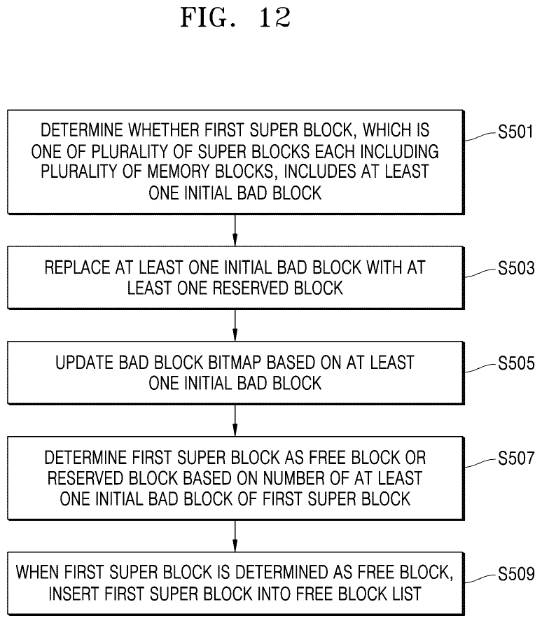

FIG. 12 is a diagram showing a method of operating a memory controller according to an embodiment.

FIG. 12 may be described with reference to FIG. 1. In operation S501, the memory controller 110 may check whether a first super block, which is one of a plurality of super blocks each including a plurality of memory blocks, includes at least one initial bad block. In operation S503, the memory controller 110 may replace the at least one initial bad block with at least one reserved block. In operation S505, the memory controller 110 may update a BBB based on the at least one initial bad block.

In operation S507, the memory controller 110 may determine the first super block as a free block or a reserved block based on the number of the at least one initial bad block in the first super block. For example, the memory controller 110 may determine the first super block as a free block or a reserved block according to the number of the at least one initial bad block in the first super block based on the BBB. The memory controller 110 may determine the first super block as the reserved block when the number of initial bad blocks of the first super block is greater than N (N is an integer greater than or equal to 0). The memory controller 110 may determine the first super block as the free block when the number of initial bad blocks of the first super block is equal to or less than a pre-set N (N is an integer greater than or equal to 0). In operation S509, when the memory controller 110 determined that the first super block is the free block, the memory controller 110 may insert the first super block into the free block list.

When the first super block includes an initial bad block, it may be considered that the reserved region is switched to an OP region. The memory controller 110 may allocate a super block for writing based on the switched OP region. In other words, the memory controller 110 may allocate a super block for writing in response to a write command. Hereinafter, operations in which the memory controller 110 allocates a super block will be described.

The memory controller 110 may select a first super block from among super blocks included in a free block list. Also, the memory controller 110 may determine whether the selected first super block is a normal super block based on the BBB. For example, when the first super block is a normal super block, the memory controller 110 may allocate the first super block for writing without considering other conditions.

Also, the memory controller 110 may allocate the selected first super block for writing when the write command is of the second type from between the first type and the second type. The first type may correspond to a host command received from the host 200, and the second type may correspond to an internal command based on the internal operation of the memory controller 110. For example, the memory controller 110 may determine whether the selected first super block is a partial super block. When the first super block is a partial super block, the memory controller 110 may determine whether the write command is of the first type or the second type. When the write command is of the second type, the memory controller 110 may allocate the first super block for writing. In this case, the first super block may be allocated for garbage collection in response to an internal command. However, at least one initial bad block of the first super block may be excluded from data striping. In other words, the memory controller 110 may exclude at least one initial bad block of the first super block from data striping and perform writing.

The memory controller 110 may allocate the first super block for writing when a write command is of the first type from between the first type and the second type and the number of free blocks included in a free block list is less than M (M is a positive integer). For example, the memory controller 110 may determine whether the selected first super block is a partial super block. When the first super block is a partial super block, the memory controller 110 may determine whether the write command is of the first type or the second type. When the write command is of the first type, the memory controller 110 may determine the number of free blocks included in the free block list. When the number of free blocks included in the free block list is less than M (M is a positive integer), the memory controller 110 may allocate the selected first block for writing. However, at least one initial bad block of the first super block may be excluded from data striping. In other words, the memory controller 110 may exclude at least one initial bad block of the first super block from data striping and perform writing. The reference number M of free blocks included in the free block list for allocation may be a pre-set value. For example, the reference number M of free blocks in the free block list for allocation may be the sum of the critical number of free blocks for garbage collection triggering and the number of partial super blocks included in the free block list.

When the write command is of the first type and the number of free blocks included in the free block list is greater than or equal to M, the memory controller 110 may re-select one of the super blocks included in the free block list. For example, the memory controller 110 may determine whether the selected first super block is a partial super block. When the first super block is a partial super block, the memory controller 110 may determine whether the write command is of the first type or the second type. When the number of free blocks included in the free block list is greater than or equal to M (M is a positive integer), the memory controller 110 may re-select one of the super blocks included in the free block list.

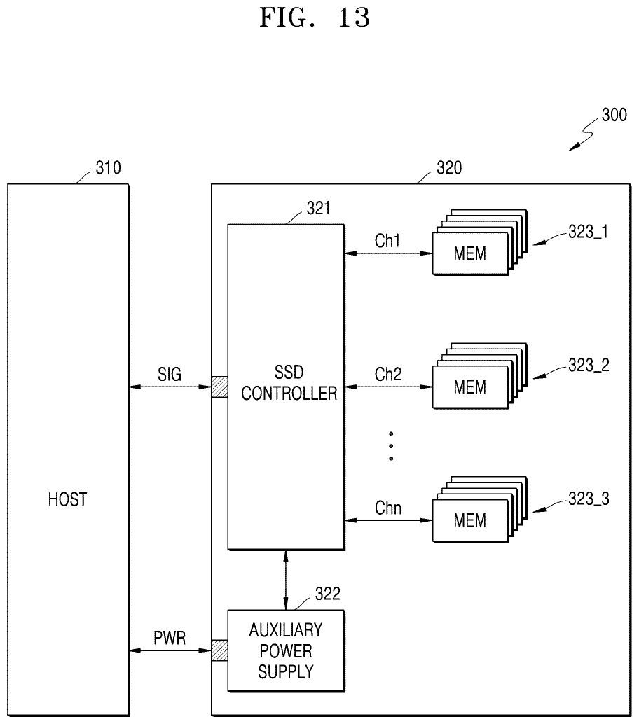

FIG. 13 is a block diagram showing an example in which a storage device according to embodiments is applied to an SSD system.

Referring to FIG. 13, a SSD system 300 may include a host 310 and an SSD 320. The SSD 320 exchanges signals with the host 310 through a signal connector and receives power through a power connector. The SSD 320 may include an SSD controller 321, an auxiliary power supply device 322, and memory devices 323_1 to 323_n. The memory devices 323_1 to 323_n may be vertically stacked NAND flash memory devices. Here, the SSD 320 may be implemented according to the embodiments described above with reference to FIGS. 1 to 12. In other words, the memory devices 323_1 to 323_n provided in the SSD 320 may each include a plurality of super blocks. Form among a plurality of super blocks of each of the memory devices 323_1 to 323_n, super blocks in a reserved region may be managed according to the method shown in FIGS. 1 to 12.

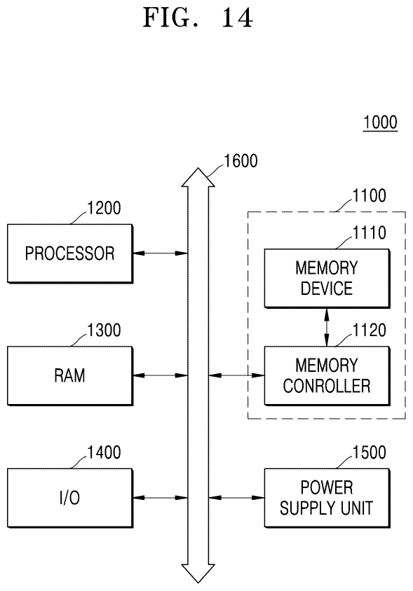

FIG. 14 is a diagram showing a computing system 1000 according to an embodiment.

Referring to FIG. 14, a computing system 1000 may include a memory system 1100, a processor 1200, a RAM 1300, an input/output device 1400, and a power supply unit 1500. Meanwhile, although not shown in FIG. 18, the computing system 1000 may further include ports capable of communicating with a video card, a sound card, a memory card, a USB device, or other electronic devices. The computing system 1000 may be implemented as a personal computer or may be implemented as a portable electronic device such as a laptop computer, a mobile phone, a personal digital assistant (PDA), and a camera.

The processor 1200 may perform particular calculations or tasks. According to embodiments, the processor 1200 may be a micro-processor or a central processing unit (CPU). The processor 1200 may communicate with the RAM 1300, the input/output device 1400, and the memory system 1100 through a bus 1600 such as an address bus, a control bus, and a data bus. At this time, the memory system 1100 may be implemented according to the embodiments illustrated in FIGS. 1 to 12. According to embodiments, the processor 1200 may also be connected to an expansion bus such as a peripheral component interconnect (PCI) bus.

The RAM 1300 may store data needed for operation of the computing system 1000. For example, the RAM 1300 may be implemented with DRAM, mobile DRAM, SRAM, PRAM, FRAM, RRAM, and/or MRAM. The input/output device 1400 may include an input units such as a keyboard, a keypad, and a mouse and an output units such as a printer and a display. The power supply unit 1500 may supply an operating voltage needed for the operation of the computing system 1000.

Various changes in form and details may be made to embodiments without departing from the spirit and scope of the following claims.

1. A storage device comprising:
a non-volatile memory comprising a first plurality of super blocks each comprising a plurality of memory blocks; and
a memory controller configured to determine that a first super block, which is one of the first plurality of super blocks, comprises at least one initial bad block, replace the at least one initial bad block with at least one reserved block, and update a bad block bitmap based on the at least one initial bad block,
wherein the memory controller comprises a super block classifier configured to determine the first super block as a free block or a reserved block according to a number of the at least one initial bad block of the first super block based on the bad block bitmap and, based on the first super block being determined as the free block, insert the first super block into a free block list, wherein the free block list identifies a second plurality of super blocks, and the first plurality of super blocks comprises the second plurality of super blocks.

2. The storage device of claim 1, wherein the super block classifier is further configured to determine the first super block as the reserved block based on a number of initial bad blocks of the first super block being greater than N that is an integer greater than 0.

3. The storage device of claim 1, wherein the super block classifier is further configured to determine the first super block as the free block based on a number of initial bad blocks of the first super block being less than or equal to pre-set N that is an integer greater than 0.

4. The storage device of claim 1, wherein the memory controller comprises a super block allocator configured to allocate the first super block for writing in response to a write command, and
wherein the super block allocator is further configured to select the first super block from among the second plurality of super blocks identified in the free block list, determine whether the first super block is a normal super block based on the bad block bitmap, and, based on the first super block being the normal super block, allocate the first super block for the writing.

5. The storage device of claim 1, wherein the memory controller comprises a super block allocator configured to allocate the first super block for writing in response to a write command,
wherein the super block allocator is further configured to:
select the first super block, which is a partial super block, from among the second plurality of super blocks identified in the free block list, and
allocate the first super block for writing based on the write command being of a second type from between a first type and the second type,
wherein the first type corresponds to a host command received from a host, and
wherein the second type corresponds to an internal command based on an internal operation of the memory controller.

6. The storage device of claim 5, wherein the memory controller is further configured to exclude the at least one initial bad block of the first super block from data striping during the writing.

7. The storage device of claim 5, wherein the internal operation comprises garbage collection.

8. The storage device of claim 1, wherein the memory controller further comprises a super block allocator configured to allocate the first super block for writing in response to a write command,
wherein the super block allocator is further configured to:
select the first super block, which is a partial super block, from among the second plurality of super blocks identified in the free block list;
allocate the first super block for writing based on the write command being of a first type from between the first type and a second type and a number of free blocks identified in the free block list is less than M that is a positive integer; and
re-select one from among the second plurality of super blocks identified in the free block list for the writing based on the write command being of the first type and the number of free blocks identified in the free block list is greater than or equal to M,
wherein the first type corresponds to a host command received from a host, and
wherein the second type corresponds to an internal command based on an internal operation of the memory controller.

9. The storage device of claim 8, wherein the memory controller is further configured to exclude the at least one initial bad block of the first super block from data striping during the writing.

10. The storage device of claim 8, wherein the M is a sum of a critical number of free blocks for garbage collection triggering and a number of partial super blocks identified in the free block list.

11. A method of operating a memory controller, the method comprising:
determining that a first super block comprises at least one initial bad block, the first super block being one of a first plurality of super blocks each comprising a plurality of memory blocks;
replacing the at least one initial bad block with at least one reserved block;
updating a bad block bitmap based on the at least one initial bad block;
determining the first super block as a free block or a reserved block according to a number of the at least one initial bad block of the first super block based on the bad block bitmap; and
inserting an identifier of the first super block into a free block list based on the first super block being determined as the free block, wherein the free block list identifies a second plurality of super blocks, and the first plurality of super blocks comprises the second plurality of super blocks.

12. The method of claim 11, further comprising determining the first super block as the reserved block based on a number of initial bad blocks of the first super block being greater than N that is an integer greater than 0.

13. The method of claim 11, further comprising determining the first super block as the free block based on a number of initial bad blocks of the first super block being less than or equal to pre-set N that is an integer greater than 0.

14. The method of claim 11, further comprising allocating the first super block for writing in response to a write command, wherein the allocating the first super block comprises:
selecting the first super block from among the second plurality of super blocks identified in the free block list;
determining whether the first super block is a normal super block based on the bad block bitmap; and
allocating the first super block for the writing based on the first super block being the normal super block.

15. The method of claim 11, further comprising allocating the first super block for writing in response to a write command,
wherein the allocating of the super block comprises:
selecting the first super block, which is a partial super block, from among the second plurality of super blocks identified in the free block list; and
allocating the first super block for writing based on the write command being of a second type from between a first type and the second type,
wherein the first type corresponds to a host command received from a host, and
wherein the second type corresponds to an internal command based on an internal operation of the memory controller.

16. The method of claim 15, further comprising excluding the at least one initial bad block of the first super block from data striping and performing the writing.

17. The method of claim 15, wherein the internal operation comprises garbage collection.

18.-22. (canceled)

23. A storage device comprising:
a non-volatile memory comprising a first plurality of super blocks each comprising a plurality of memory blocks; and
a memory controller configured to determine whether a first super block, which is one of the first plurality of super blocks, comprises at least one initial bad block, and replace the at least one initial bad block with at least one reserved block,
wherein the memory controller comprises:
a super block classifier configured to determine the first super block as a free block and insert the first super block into a free block list based on a number of the at least one initial bad block of the first super block being less than or equal to pre-set K that is an integer greater than or equal to 1, wherein the free block list identifies a second plurality of super blocks, and the first plurality of super blocks comprises the second plurality of super blocks, and
a super block allocator configured to allocate the first super block for writing in response to a write command.

24. The storage device of claim 23, wherein the super block allocator is further configured to select a second super block, which is any one from among the second plurality of super blocks identified in the free block list, in response to a write command, determine whether at least one condition from among conditions for allocating the second super block is satisfied, and, based on the at least one condition being satisfied, allocate the second super block for the writing, and
the conditions comprise a first condition that the second super block is a normal super block, a second condition that the write command is of a second type from between a first type and the second type, and a third condition that a number of super blocks identified in the free block list is less than M.

25. The storage device of claim 24, wherein the super block allocator is further configured to select a third super block, which is any one of the second plurality of super blocks identified in the free block list, in response to the write command based on none of the conditions being satisfied, and
wherein the third super block is different from the second super block.
